(19) United States
(12) Patent Application Publication
(10) Pub. No.: US 2025/0013616 A1
(43) Pub. Date: Jan. 9, 2025

(54) EXPERIMENTAL INFORMATION MANAGEMENT SYSTEMS, METHODS, AND IMAGING SYSTEMS

(71) Applicant: WUHAN UNITED IMAGING LIFE SCIENCE INSTRUMENT CO.,LTD, WUHAN, Hubei (CN)

(72) Inventors: OU XIONG, WUHAN (CN); ZHIBO XU, WUHAN (CN); WENTING XU, WUHAN (CN)

(21) Appl. No.: 18/709,034

(22) PCT Filed: Dec. 9, 2021
(86) PCT No.: PCT/CN2021/136789

§ 371 Date: May 10, 2024

(30) Foreign Application Priority Data
Dec. 31, 2020 (CN) 202011633100.X
Nov. 11, 2021 (CN) 202111334613.5

(51) Int. Cl. G06F 16/215; G06F 16/23

(52) U.S. Cl. CPC G06F 16/215; G06F 16/2365

(57) ABSTRACT

Embodiments of the present disclosure provide an experimental information management system, a method, and an imaging system. The experimental information management system comprises an experimental data center module configured to store at least one piece of historical experimental data, an experimental information management module configured to select and determine to-be-processed experimental data in response to a selection operation, and an experimental information registration module configured to modify the to-be-processed experimental data in response to a modification operation and generate target experimental data.

### CROSS REFERENCE TO RELATED APPLICATIONS

This application claims the priority of Chinese Patent Application No. 202011633100.X, entitled “INFORMATION MANAGEMENT METHODS, SCANNING REGISTRATION METHODS AND DEVICES THEREOF FOR EXPERIMENTAL SUBJECTS OF ANIMAL IMAGING,” filed on Dec. 31, 2020, and Chinese Patent Application No. 202111334613.5, entitled “EXPERIMENTAL INFORMATION MANAGEMENT SYSTEMS, METHODS AND IMAGING SYSTEMS,” filed on Nov. 11, 2021, the contents of each of which are incorporated herein by reference.

### TECHNICAL FIELD

The present disclosure relates to the field of life sciences and technology, and in particular, to experimental information management systems, methods, and imaging systems.

### BACKGROUND

Animal experiments have an irreplaceable role in life science research (e.g., the development of new drugs and the study of the pathogenesis of major brain diseases, etc.), which require the use of appropriate live animals for experiments. In order to improve the reliability and validity of the results of animal experiments, animals usually need to be grouped in animal experiments, and each group may include individual animals having similar basic information, and experiments on multiple individual animals in each group need to be performed respectively.

In the prior art, an experimenter is required to register an experiment on individual animals, and due to the large amount of experimental information required to be registered for animal experiments, the following technical problem exists: due to the large amount of information that needs to be registered, misregistration may exist in the registration of experimental information; due to the need for experimenter to conduct experimental registration of individual animals, the registration time is relatively long, and experimental efficiency is relatively low.

### SUMMARY

In view of the foregoing, there is a need to provide an experimental information management system, a method, and an imaging system for solving the technical problems in the prior art (e.g., misregistration, a relatively low efficiency of animal experiments due to a relatively long registration time).

On the one hand, one of the embodiments of the present disclosure provides an experimental information management system including an experimental data center module, an experimental information management module, and an experimental information registration module.

The experimental data center module is configured to store at least one piece of historical experimental data that has been registered.

The experimental information management module is configured to, in response to a determination operation, select at least one candidate piece of historical experimental data from the experimental data center module and determine to-be-processed experimental data from the at least one candidate piece of historical experimental data.

The experimental information registration module is configured to, in response to a modification operation, modify the to-be-processed experimental data to generate target experimental data.

The experimental data center module is further configured to, in response to a registration operation, store the target experimental data.

In some embodiments, the experimental information management module includes a selection unit and a determination unit.

The selection unit is configured to select the at least one candidate piece of historical experimental data from the experimental data center module based on a selection keyword.

The determination unit is configured to determine, in response to a determination operation, the to-be-processed experimental data from the at least one candidate piece of historical experimental data.

In some embodiments, the historical experimental data includes a historical experimental animal data block and a historical experimental scanning data block. The modification operation includes an overall replacement sub-operation, and the experimental information registration module includes a data block replacement unit.

The data block replacement unit is configured to perform an overall replacement on a historical experimental animal data block or a historical experimental scanning data block in the to-be-processed experimental data in response to the overall replacement sub-operation.

In some embodiments, the data block replacement unit includes a data block retrieve sub-unit and a data block replacement sub-unit.

The data block retrieve sub-unit is configured to retrieve at least one piece of to-be-selected historical experimental data from the experimental data center module based on a replacement keyword. The replacement keyword is different from the selection keyword.

The data block replacement sub-unit is configured to determine, in response to a determination operation, target to-be-selected historical experimental data from the at least one piece of to-be-selected historical experimental data, and replace a historical experimental animal data block in the to-be-processed experimental data with a historical experimental animal data block in the target to-be-selected historical experimental animal data block or replace a historical experimental scanning data block in the to-be-processed experimental data with a historical experimental scanning data block in the target to-be-selected historical experimental data.

In some embodiments, the historical experimental data includes a plurality of historical experimental data items. The modification operation further includes a single modification sub-operation, and the experimental information registration module further includes a data modification unit.

The data modification unit is configured to modify, in response to a single-unit modification sub-operation, at least one historical experimental data item in a plurality of historical experimental data items in the to-be-processed experimental data.

In some embodiments, the experimental information registration module further includes a memory unit.

The memory unit is configured to record a registered experimenter and/or experimental project.

The data modification unit is further configured to select, in response to the single-item modification sub-operation, a target experimenter and/or a target experimental project from the names of the registered experimenters and/or the names of the registered experimental projects.

In some embodiments, the experimental information registration module is further configured to generate a new experimental number, replace a historical experimental number in the to-be-processed experimental data, and generate target experimental data with the new experimental number.

In some embodiments, the data replacement sub-unit includes a determination sub-unit, an animal data updating sub-unit and an animal data replacement sub-unit.

The determination sub-unit is configured to, in response to a determination operation, determine target to-be-selected historical experimental data from the at least one piece of to-be-selected historical experimental data.

The animal data updating sub-unit is configured to update a historical animal data block in the target to-be-selected historical experimental data.

The animal data replacement sub-unit is configured to replace a historical experimental animal data block in the to-be-processed experimental data with an updated historical experimental animal data block in the target to-be-selected historical experimental data.

In some embodiments, the animal data updating sub-unit includes an updated model establishment sub-unit and an animal data information updating sub-unit.

The updated model establishment sub-unit is configured to establish an animal information updating model for an individual animal.

The animal data information updating sub-unit is configured to update a historical experimental animal data block in the target to-be-selected historical experimental data based on the animal information updating model.

In some embodiments, the historical experimental animal data block includes at least one of an animal number, an animal name, a species type, an animal age, or an animal weight.

In some embodiments, the historical experimental scanning data block includes a historical experimental basic data block, a historical scanning protocol and a historical placement position, the historical experimental basic data block includes at least one of an experimental number, an experimental name, an experimenter, or an experimental project.

On the other hand, one of the embodiments of the present disclosure further provides an experimental information management method applicable to the experimental information management system described in any one of the above embodiments, the experimental information management method comprising one or more of the following operations.

At least one piece of historical experimental data that has been registered is stored using an experimental data center module.

At least one candidate piece of historical experimental data is selected from the experimental data center module, in response to a selection operation using an experimental information management module, and to-be-processed experimental data is determined from the at least one candidate piece of historical experimental data.

Target experimental data is generated by modifying the to-be-processed experimental data, in response to a modification operation using an experimental information registration module.

The target experimental data is stored in response to a registration operation using the experimental data center module.

On the other hand, one of the embodiments of the present disclosure further provides an imaging system comprising an experimental information management system and a scanning system.

The scanning system is configured to retrieve target experimental data from the experimental information management system in response to a scanning operation and perform scanning based on the target experimental data.

The experimental information management system is an experimental information management system described in any one of the above possible implementations.

In some embodiments, the scanning system includes a receiving unit, a retrieving unit, and a scanning unit.

The receiving unit is configured to receive an experimental number of the target experimental data.

The retrieving unit is configured to retrieve the target experimental data from the experimental data center module based on the experimental number of the target experimental data.

The scanning unit is configured to scan an object based on the target experimental data.

In some embodiments, the scanning system includes a verifying module. The verifying module may be configured to verify whether the target experimental data is correct, and when the target experimental data is correct, scanning may be performed according to the target experimental data.

According to the experimental information management system provided in the embodiments of the present disclosure, the to-be-processed experimental data is firstly selected from the at least one piece of historical experimental data by the experimental information management module, and then the to-be-processed experimental data is modified by the experimental information registration module, and the target experimental data may be generated, which eliminates the need for experimenters to register individual animals before each experiment, effectively avoids the problem of misregistration and shortens the registration time, thus improving the animal experiment efficiency.

### BRIEF DESCRIPTION OF THE DRAWINGS

In order to more clearly illustrate the technical solutions in the embodiments of the present disclosure, the accompanying drawings that need to be used in the description of the embodiments will be briefly introduced below, and it will be obvious that the accompanying drawings in the following description are only some of the embodiments of the invention, and other attachments can also be obtained according to them without creative labor to a person skilled in the art.

FIG. 1 is a schematic diagram illustrating an exemplary experimental information management system according to some embodiments of the present disclosure;

FIG. 2 is a schematic diagram illustrating another exemplary experimental information management system according to some embodiments of the present disclosure;

FIG. 3 is a schematic diagram illustrating an exemplary interactive interface according to some embodiments of the present disclosure;

FIG. 4 is a schematic diagram illustrating an exemplary first working state of the interactive interface according to some embodiments of the present disclosure;

FIG. 5 is a schematic diagram illustrating an exemplary experimental information management module according to some embodiments of the present disclosure;

FIG. 6 is a schematic diagram illustrating an exemplary second working state of the interactive interface according to some embodiments of the present disclosure;

FIG. 7 is a schematic diagram illustrating an exemplary experimental information registration module according to some embodiments of the present disclosure;

FIG. 8 is a schematic diagram illustrating an exemplary third working state of the interactive interface according to some embodiments of the present disclosure;

FIG. 9 is a schematic diagram illustrating an exemplary fourth working state of the interactive interface according to some embodiments of the present disclosure;

FIG. 10 is a flowchart illustrating an exemplary experimental information method according to some embodiments of the present disclosure;

FIG. 11 is a block diagram illustrating an exemplary imaging system according to some embodiments of the present disclosure; and

FIG. 12 is a block diagram illustrating an exemplary scanning system according to some embodiments of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only a portion of the embodiments of the present disclosure, and not all of the embodiments. Based on the embodiments in the present disclosure, all other embodiments obtained by a person skilled in the art without making creative labor fall within the scope of protection of the present disclosure.

In the description of embodiments of the present disclosure, “plurality” is meant to be two or more unless otherwise indicated. The term “and/or”, which describes the associative relationship of the associated objects, indicates that three relationships can exist, e.g., A and/or B, which means: only A, both A and B, and only B.

References to “embodiments” herein imply that particular features, structures, or characteristics described in conjunction with embodiments may be included in several embodiments of the present disclosure. The presence of this phrase at various points in the present disclosure does not necessarily always refer to the same embodiments, nor is it a separate or alternative embodiment that is mutually exclusive of other embodiments. It is understood by those skilled in the art, both explicitly and implicitly, that the embodiments described herein may be combined with other embodiments.

Embodiments of the present disclosure provide an experimental information management system, a method, and an imaging system, each of which is described below.

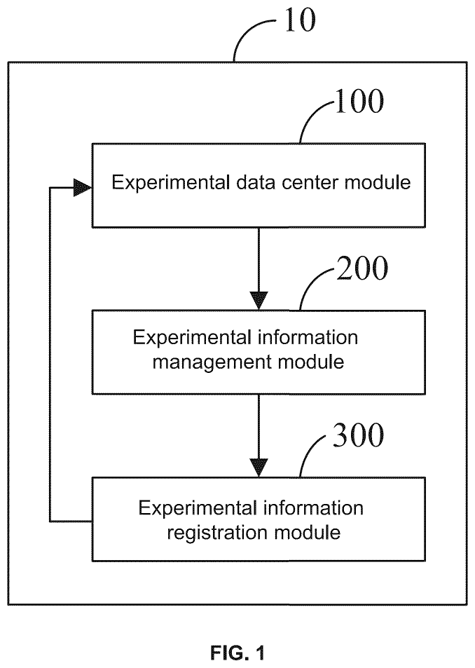

FIG. 1 is a schematic diagram illustrating an exemplary experimental information management system according to some embodiments of the present disclosure. As shown in FIG. 1, the experimental information management system 10 includes an experimental data center module 100, an experimental information management module 200 and an experimental information registration module 300.

The experimental data center module 100 is configured to save at least one piece of historical experimental data that has been registered.

The experimental information management module 200 is configured to select, in response to a determination operation, at least one candidate piece of historical experimental data from the experimental data center module 100 and determine to-be-processed experimental data from the at least one candidate piece of historical experimental data.

The experimental information registration module 300 is configured to modify, in response to a modification operation, the to-be-processed experimental data and generate target experimental data.

The experimental data center module 100 is further configured to store, in response to a registration operation, the target experimental data.

In some embodiments of the present disclosure, the experimental information management system 10 firstly selects the to-be-processed experimental data from the at least one candidate piece of historical experimental data through the experimental information management module 200, and then generates the target experimental data by modifying the to-be-processed experimental data through the experimental information registration module 300 to generate the target experimental data. That is, the target experimental data may be generated by making a modification on the to-be-processed experimental data, without requiring experimental personnel to register information of an individual animal before each experiment, which effectively avoids the technical problem of misregistering, and shortens the time of registration, thus improving the efficiency of animal experiments.

Besides, by storing the target experimental data in the experimental data center module 100, it may be realized that at least one piece of target experimental data may be generated before scanning, and it is avoided that each time the scanning is performed, the target experimental data is registered again before the scanning. That is, the pre-registration may be realized, and the experimental information management system 10 may further improve the animal experimental efficiency by setting up the pre-registration.

In some embodiments, the determination operation, the modification operation, and the registration operation may be issued by a user (e.g., a lab technician) who performs the registration.

In some embodiments, the historical experimental data includes a historical experimental animal data block and a historical experimental scanning data block. The historical experimental scanning data block includes a historical experimental basic data block, a historical scanning protocol, and a historical positioning. The historical experimental animal data block includes experimental data items such as an animal number, an animal name, a species type, an animal age, and an animal weight, etc., of a scanned object. The historical experimental basic data block includes historical experimental data items such as an experimental number, an experimental name, an experimenter, and an experimental project.

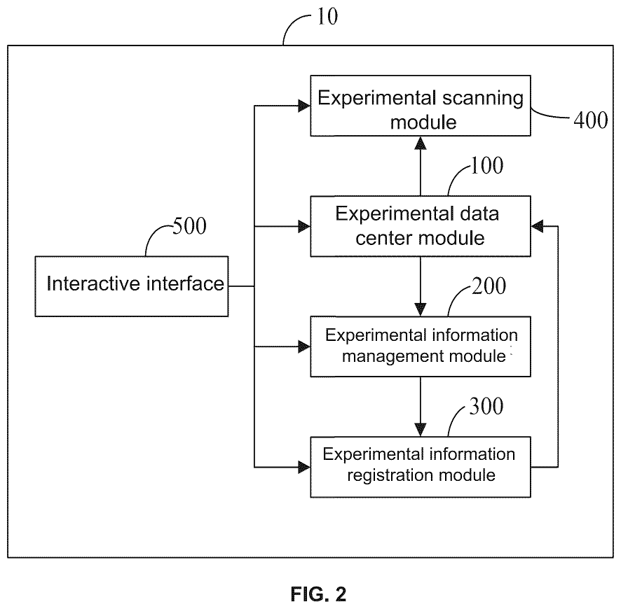

In order to improve the interactivity of the experimental information management system, in some embodiments, as shown in FIG. 2, the experimental information management system 10 also includes an interactive interface 500 on which the user performs the determination operation, the modification operation, the registration operation, etc.

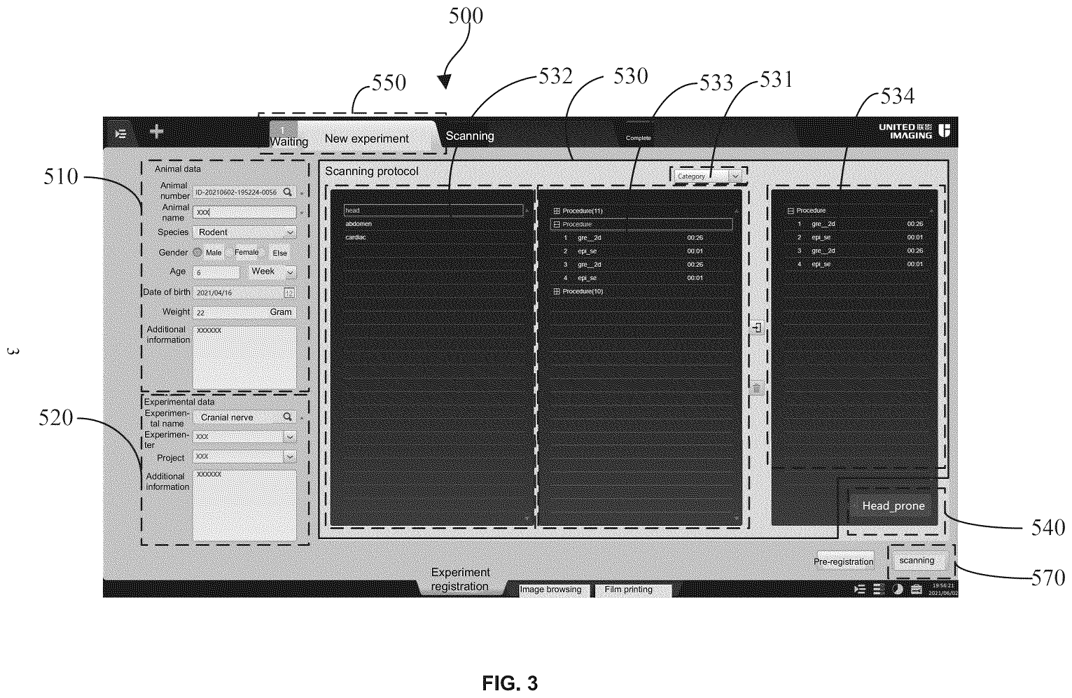

Besides, in order to facilitate the user to visualize the target experimental data, the interactive interface 500 may also be configured to display the target experimental data. In some embodiments, as shown in FIG. 3, the interactive interface 500 includes an animal experimental data block interaction and display region 510, an experimental basic data block interaction and display region 520, a scanning protocol interaction and display region 530, a placement position interaction and display region 540, and a header information region 550.

The animal experimental data block interaction and display region 510 is configured to display an animal experimental data block and respond to the determination operation and modification operation to modify animal historical experimental data items such as an animal number, an animal name, a species type, an animal age, and an animal weight in the animal experimental data block. The animal experimental data block interaction and display region 510 includes animal experimental data item sub-regions corresponding to the animal historical experimental data items, each animal experimental data item sub-region is configured to modify and display animal historical experimental data items corresponding to the animal experimental data item sub-region.

The experimental basic data block interaction and display region 520 is configured to display an experimental data block, respond to the determination operation and modification operation, and modify historical experimental data items such as an experimental name, an experimenter and an experimental project. The experimental basic data block interaction and display region 520 includes historical experimental data item sub-regions corresponding to the historical experimental data items, each experimental data item sub-region is configured to modify and display historical experimental data item(s) corresponding to the experimental data item sub-region.

In some embodiments, the experimental number is unique, and an experimental number is different for the historical experimental data and the target experimental data.

In some embodiments, the experimental information registration module 300 is further configured to generate a new experimental number that replaces a historical experimental number in the to-be-processed experimental data and generates target experimental data with the new experimental number.

In some embodiments, a specific work process of the experimental information registration module 300 is to generate the new experimental number to replace the historical experimental number in the to-be-processed experimental data, and then, according to the modification operation, modify historical experimental data items in the to-be-processed experimental data except for the new experimental number in the to-be-processed experimental data to generate the target experimental data.

The scanning protocol interaction and display region 530 includes four sub-regions, namely a Category sub-region 531, a BigbodyPart sub-region 532, a Procedure sub-region 533, and a target Procedure sub-region 534. The scanning protocols in the Category sub-region 531 have different categories. The scanning protocols in the BigbodyPart sub-region 532 are used for different parts and belong to any same category. The scanning protocols in the Procedure sub-region 533 include a plurality of protocol groups corresponding to scanning protocols for any one of different scanning parts. The scanning protocols in the target Procedure sub-region 534 include a target protocol group selected from the plurality of protocol groups in the Procedure sub-region 533.

A specific workflow of the scanning protocol interaction and display region 530 is as follows: if the category of the scanning protocol(s) in the Category sub-region 531 is changed, the BigbodyPart sub-region 532 may display a list of protocols for scanning parts corresponding to a changed category of scanning protocols; if a protocol of a certain scanning part is selected, the Procedure sub-region 533 may display protocol groups corresponding to a currently selected protocol for the scanning part; each protocol group may be unfolded to display all protocols contained in a current protocol group; if a certain protocol group in the Procedure sub-region is selected as a target protocol group, the target protocol group may be added to the target Procedure sub-region 534, and a scanning system may scan and image the scanned object according to the target protocol group in this sub-region.

The placement position interaction and display region 540 is configured to select a placement position of an animal. For example, the placement position of the animal may be lying down, lying flat, lying on the side, forward positioning, reverse positioning, etc.

The header information region 550 is configured to display a name of an experiment currently undergoing registration.

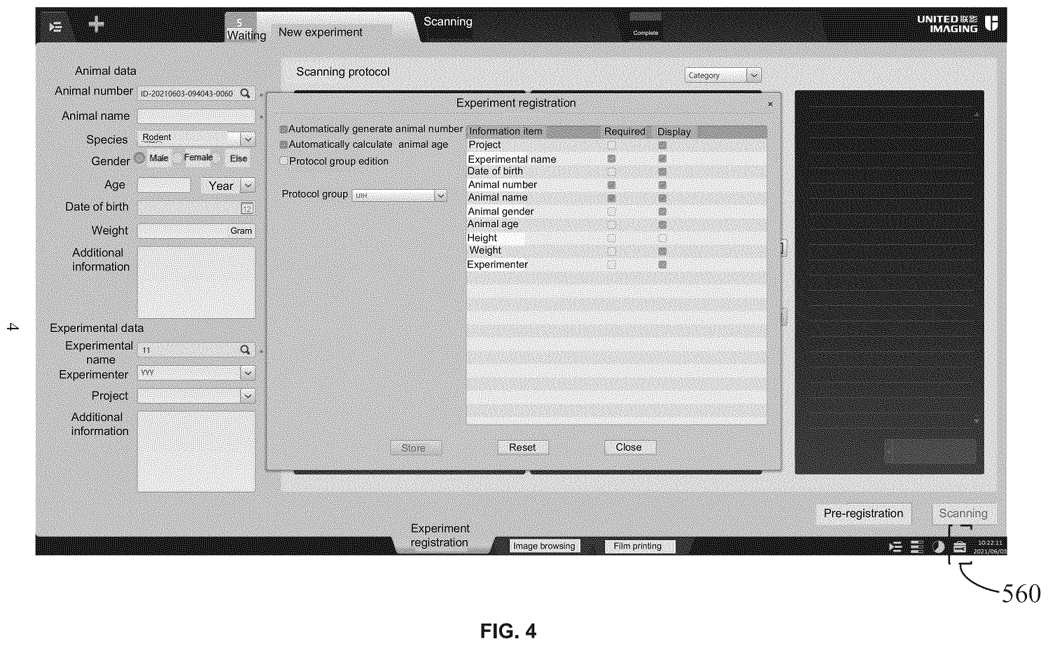

In some embodiments, as shown in FIG. 4, the experimental information management system 10 further includes a system configuration module, which is configured to customize, in response to a click, settings for a system configuration. In some embodiments, the system configuration module includes a toolbox 560 configured to customize settings for “experimental registration configuration”. Specifically, by clicking on an icon of the toolbox 560 in the interactive interface 500, a pop-up window for “experimental registration configuration” is displayed, in which mandatory and display items may be set.

In some embodiments, the determination operation includes a selection keyword. The selection keyword may be at least one of a historical experimental data item such as an animal number, an animal name, a species type, an animal age, an animal weight, an experimental number, an experimental name, an experimenter, or an experimental project.

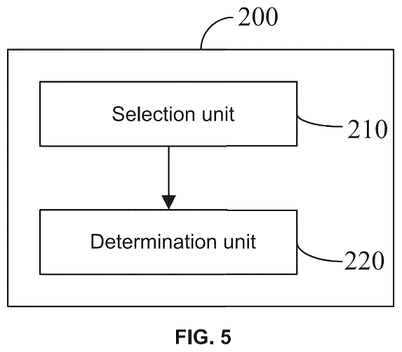

As shown in FIG. 5, the experimental information management module 200 includes a selection unit 210 and a determination unit 220.

The selection unit 210 is configured to select the at least one candidate piece of historical experimental data from the experimental data center module 100 based on the selection keyword. It is understood that based on the selection keyword, the at least one candidate piece of historical experimental data may include only one piece or a plurality of pieces, and a result is displayed according to a keyword input by the user and matched historical experimental data.

The determination unit 220 is configured to determine, in response to a determination operation, the to-be-processed experimental data from the at least one candidate piece of historical experimental data.

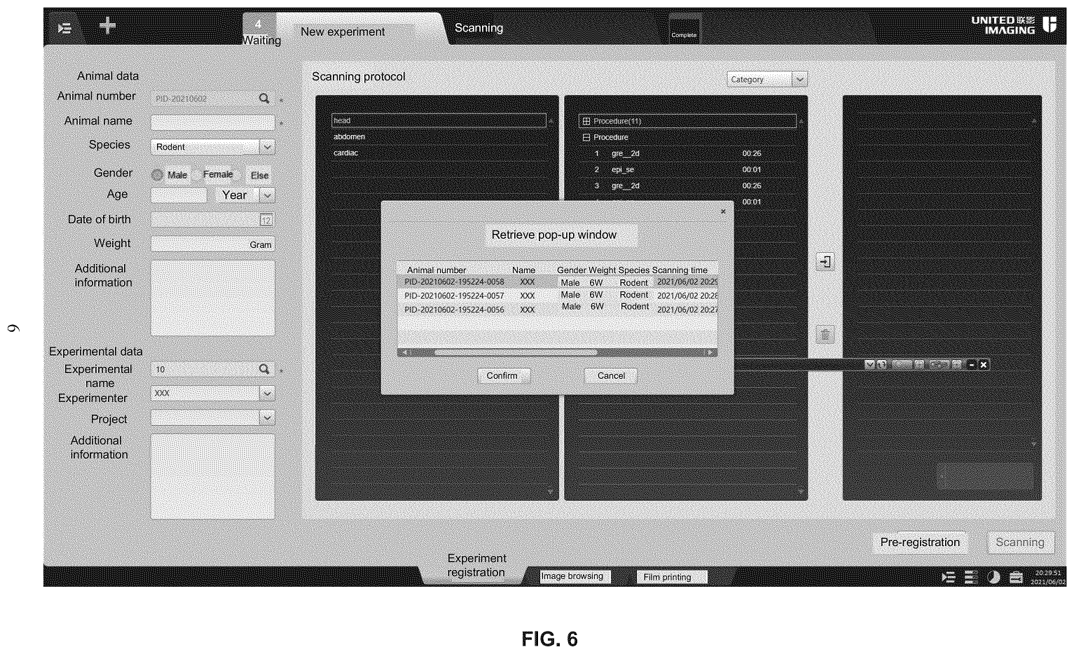

In some embodiments, as shown in FIG. 6, the selection keywords include an animal number and a species type. If the animal number is “PID-20210602” and the species type is “rodent”, the selection unit 210 may screen out three candidate pieces of historical experimental data. The three candidate pieces of historical experimental data are presented to the user in a form of a search pop-up window, and the user may select any one of the candidate pieces of historical experimental data as the to-be-processed experimental data.

In some embodiments of the present disclosure, the user may select one candidate piece of historical experimental data most similar to the target experimental data as the to-be-processed experimental data within the search pop-up window to reduce a count of modifications required in the experimental information registration module 300, and further improve the animal experimental efficiency.

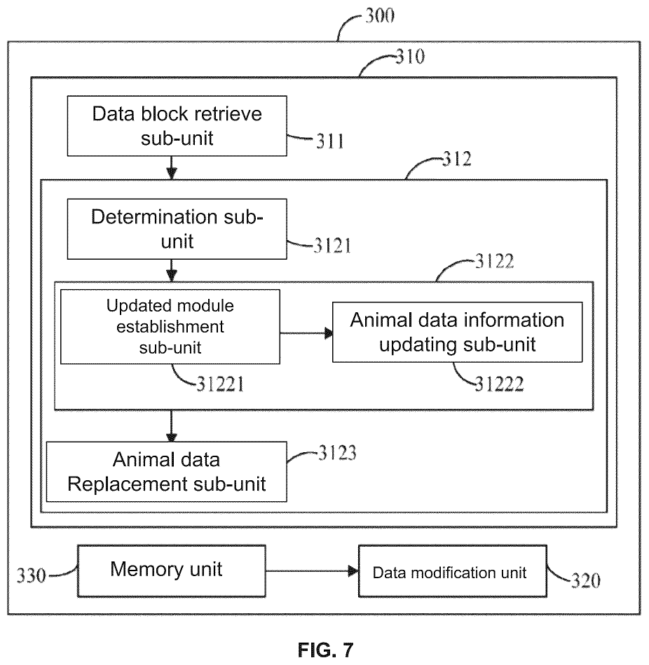

In some embodiments, the modification operation includes an overall replacement sub-operation, and the experimental information registration module 300 includes a data block replacement unit 310, as shown in FIG. 7.

The data block replacement unit 310 is configured to perform, in response to the overall replacement sub-operation, an overall replacement on a historical experimental animal data block or a historical experimental scanning data block in the to-be-processed experimental data.

In some embodiments, if the overall replacement is performed on a historical experimental animal data block or a historical experimental scanning data block in the data block replacement unit 310, an overall replacement item may be set to achieve the replacement of all data items in the historical experimental animal data block or the historical experimental scanning data block or achieve replacement of some data items in the historical experimental animal data block or the historical experimental scanning data block. The overall replacement item may be a default overall replacement item of the system, and the overall replacement item may be user-defined through the system configuration module.

For example, if the user sets an overall replacement item of the historical animal data block to be an animal name, a species type, and an animal age, then when an overall replacement operation is performed on the historical animal data block, the replacement of other animal data items other than the overall replacement item is not performed.

In some embodiments of the present disclosure, by setting the historical experimental animal data block or the historical experimental scanning data block to be replaceable in its entirety, it is possible to prevent the user from modifying each historical experimental animal data item in the historical experimental animal data block or each historical experimental scanning data item in the historical experimental scanning data block sequentially, thereby realizing the technical effect of reducing the count of modifications and improving the animal experimental efficiency.

In some embodiments, the overall replacement sub-operation includes a replacement keyword. The replacement keyword may be at least one of a historical experimental data item such as an animal number, an animal name, a species type, an animal age, an animal weight, an experimental number, an experimental name, an experimenter, or an experimental project, and the replacement keyword is not the same as the selection keyword. In some embodiments, the replacement keyword is an animal number, an animal name, and/or an experimental name. The historical experimental animal data block may be searched by the animal number or the animal name for overall replacement. The historical experimental scanning data block may be searched by the experimental name for overall replacement.

As shown in FIG. 7, the data block replacement unit 310 includes a data block retrieve sub-unit 311 and a data block replacement sub-unit 312.

The data block retrieve sub-unit 311 is configured to retrieve at least one piece of to-be-selected historical experimental data from the experimental data center module based on the replacement keyword.

The data block replacement sub-unit 312 is configured to determine, in response to the determination operation, target to-be-selected historical experimental data from the at least one piece of to-be-selected historical experimental data, and replace a historical experimental animal data block in the to-be-processed experimental data with a historical experimental animal data block in the target to-be-selected historical experimental data or replace a historical experimental scanning data block in the to-be-processed experimental data with a historical experimental scanning data block in the to-be-selected historical experimental data to generate the target experimental data.

In some embodiments of the present disclosure, the target to-be-selected historical experimental data is to-be-selected historical experimental data that is the most similar to the target experimental data to reduce the count of modifications required in the to-be-selected historical experimental data and to further improve the animal experimental efficiency.

In some embodiments, as shown in FIG. 7, the data block replacement sub-unit 312 includes a selection sub-unit 3121, an animal data updating sub-unit 3122, and an animal data replacement sub-unit 3123.

The selection sub-unit 3121 is configured to determine, in response to a determination operation, target to-be-selected historical experimental data from the at least one candidate piece of historical experimental data.

The animal data updating sub-unit 3122 is configured to update the historical animal data block in the target to-be-selected historical experimental data.

The animal data replacement sub-unit 3123 is configured to replace the historical animal data block in the to-be-processed experimental data with the updated historical animal data block in the target to-be-selected historical experimental data.

In some embodiments, by setting the animal data updating sub-unit 3122 to update the historical animal data block in the target to-be-selected historical experimental data, so as to ensure the reliability of the historical animal data block.

In some embodiments, as shown in FIG. 7, the animal data updating sub-unit 3122 includes an updated model establishment sub-unit 31221 and an animal data information updating sub-unit 31222.

The updated model establishment sub-unit 31221 is configured to establish an animal information updating model for an individual animal.

The animal data information updating sub-unit 31222 is configured to update a historical animal data block in the target to-be-selected historical experimental data.

The animal information updating model automatically determines an animal age, animal weight, animal length and health status of an individual animal based on a species of the individual animal, a date of birth of the individual animal, and a selection time of a historical experimental animal data block in the target to-be-selected historical experimental data.

In some embodiments, the individual animal includes, but is not limited to, a rat, a mouse, and a rabbit.

In some embodiments, by setting the animal data information updating sub-unit 3122, the animal age, animal weight, animal length, and health status of an individual animal may be automatically determined by the animal information updating model without the need for the staff to measure and manually calculate the animal age, animal weight, animal length, and health status of the individual animal each time, which improves the efficiency of the generation of the target experimental data and reducing the error rate of the target experimental data.

In some embodiments, the animal data information updating sub-unit 3122 may set a number corresponding to each individual animal. Each number of each individual animal is unique, and each number corresponds to a species, a date of birth, a weight, a length, and a health condition of the individual animal. In the case that each experiment requires a different individual animal, or the individual animal is replaced, corresponding animal data information may be obtained based on the number to update the historical animal data block in the target to-be-selected historical experimental data.

If the to-be-processed experimental data is more similar to the target experimental data, there is no need to replace the historical experimental animal data block in its entirety, or only minor modifications need to be made. Alternatively, if the historical experimental animal data block is replaced in its entirety, it may also need to modify a historical experimental data item. In order to make the experimental information management system 10 applicable to both of the above scenarios, in some embodiments, the modification operation further includes a single-item modification sub-operation, as shown in FIG. 7, and the experimental information registration module 300 further includes a data modification unit 320.

The data modification unit 320 is configured to modify, in response to the single-unit modification sub-operation, at least one historical experimental data item of a plurality of historical experimental data items in the to-be-processed experimental data.

The historical experimental data items include the animal number, the animal name, the species type, the animal age, the animal weight, etc. in the historical experimental animal data block, and/or the experimental name, the experimenter, and the experimental project in the historical experimental scanning data block.

By setting the data modification unit 320 to modify at least one type of data in the historical experimental data items such as the animal number, the animal name, the species type, the animal age, the animal weight, the experimental name, the experimenter, and the experimental project, a modification method different from the data block replacement unit 310 is provided for the modification of the to-be-processed experimental data, improving the modification variety of the to-be-processed experimental data.

In some embodiments, the data modification unit 320 may further modify the at least one historical experimental data item that has been modified by the data block replacement unit 310.

In order to avoid the technical problem of manually inputting a to-be-modified experimenter and to-be-modified experimental project each time the experimental information management system 10 is used, resulting in a misinput, and for personnel using the experimental information management system 10 and/or the experimental project conducted in a relatively fixed scenario, in some embodiments, as shown in FIG. 7, the experimental information registration module 300 further includes a memory unit 330.

The memory unit 330 is configured to record a registered experimenter and/or a registered experimental project.

The data modification unit 320 is further configured to select, in response to the single-unit modification sub-operation, a target experimenter and/or a target experimental project from the registered experimenters and/or the registered experimental projects for modification of the target experimenter and/or the target experimental project.

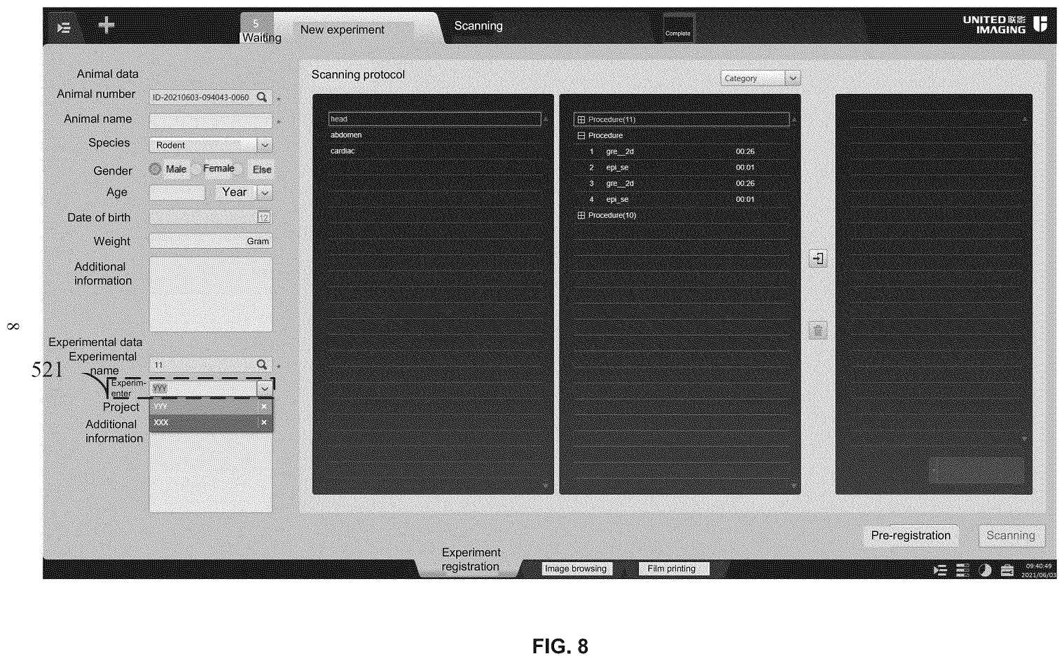

In some embodiments, as shown in FIG. 8, the experimental basic data block interaction and display region 520 includes an experimenter sub-region 521, and the experimenter sub-region 521 includes a drop-down column from which the user may click to select an experimenter that has been registered without manually inputting the experimenter.

In some embodiments of the present disclosure, by providing the memory unit 330, a probability of the experimenter or the experimental project being incorrectly input can be further reduced, and the animal experimental efficiency can be further improved.

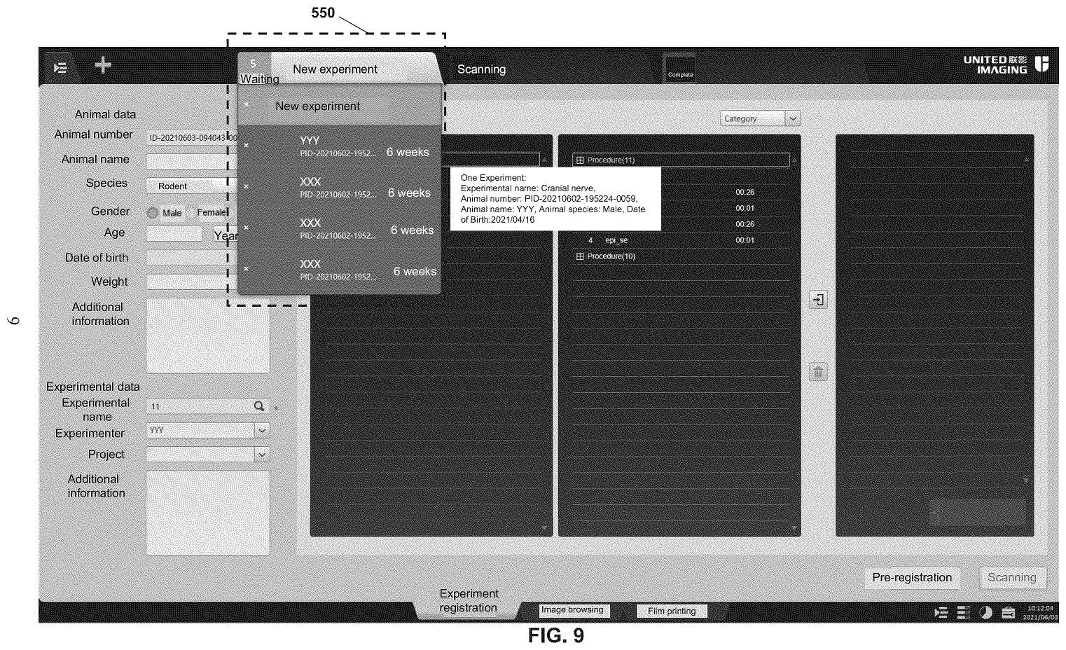

In some embodiments, as shown in FIG. 9, the header information region 550 is further configured to display all pieces of registered target experimental data, e.g., display all experimental names of target experimental data that has been registered. Before an experimental scanning module 400 performs scanning, when a mouse hovers over the respective target experimental data, preview information of the respective target experimental data may be generated, e.g., the preview information in a white region in FIG. 9. The preview information may include at least one of an animal number, an animal name, a species type, an experimental name, or an experimental project. Through the preview information, it is convenient for the user to select specific target experimental data for experiment.

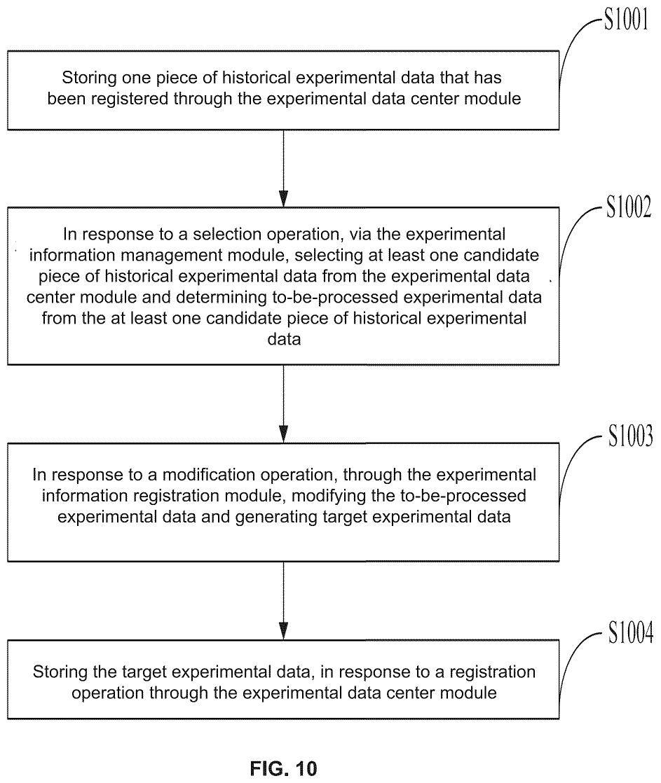

One of the embodiments of the present disclosure further provides an experimental information management method, applicable to any one of the above embodiments of the experimental information management system, as shown in FIG. 10, the experimental information management method includes one or more of the following operations.

S1001, at least one piece of historical experimental data that has been registered through the experimental data center module 100 may be stored.

S1002, in response to a selection operation, at least one candidate piece of historical experimental data may be selected, via the experimental information management module 200, from the experimental data center module 100, and to-be-processed experimental data may be determined from the at least one candidate piece of historical experimental data.

S1003, in response to a modification operation, the to-be-processed experimental data may be modified through the experimental information registration module 300, and target experimental data may be generated.

S1004, the target experimental data may be stored, in response to a registration operation through the experimental data center module 100.

The experimental information management method provided in the above embodiments can realize the technical solutions described in the above embodiments of the experimental information management system, and the principles of the specific realization of each of the units or sub-units described above can be found in the corresponding contents in the above embodiments of a clustered upgrading system, which are not repeated herein.

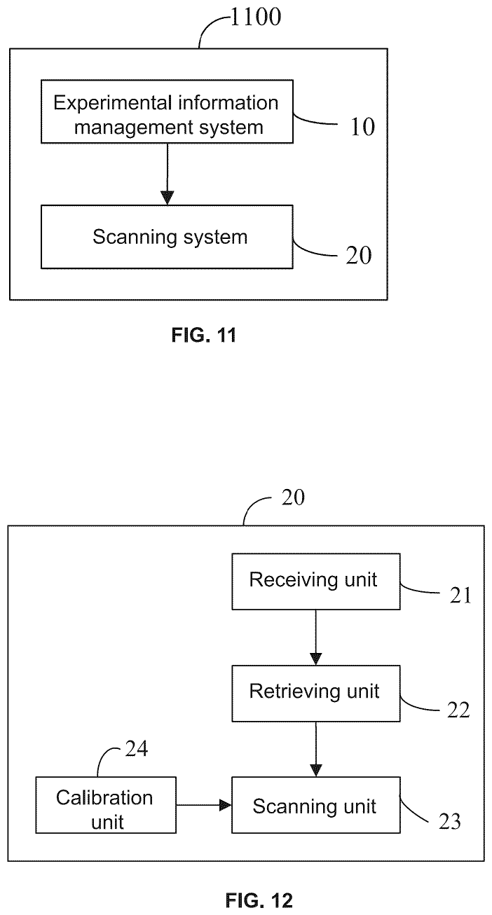

One of the embodiments of the present disclosure provides an imaging system. As shown in FIG. 11, the imaging system 1100 includes an experimental information management system 10 and a scanning system 20.

The scanning system 20 is configured to respond to a scanning operation to retrieve target experimental data from the experimental information management system 10 and perform scanning based on target experimental data.

The experimental information management system 10 is an experimental information management system in any one of the above embodiments of the experimental information management system.

In some embodiments, the scanning system 20 includes a receiving unit 21, a retrieving unit 22, and a scanning unit 23, as shown in FIG. 12.

The receiving unit 21 is configured to receive an experimental number of the target experimental data.

The retrieving unit 22 is configured to retrieve the target experimental data from the experimental data center module 100 according to the experimental number of the target experimental data.

The scanning unit 23 is configured to scan an object based on the target experimental data.

In order to avoid scanning the target experimental data when the target experimental data is incorrect or the experimental data is missed, which results in an invalid scanning result, in some embodiments, as shown in FIG. 12, the scanning system 20 further includes a verifying unit 24. The verifying unit 24 is configured to verify whether the target experimental data is correct, and when the target experimental data is correct, the object is scanned to obtain the target experimental data.

In some embodiments, in order to avoid a technical problem in which a scanning unit 23 scans the target experimental data when the scanning system 20 already has an experimental that is being scanned, which results in a scanning error occurring in the scanning system 20, or when the scanning system 20 fails, the scanning unit 23 still scans the object to obtain the target experimental data, resulting in the technical problem of not being able to scan effectively. In some embodiments, as shown in FIG. 3, the interactive interface 500 of the experimental information management system 10 also includes an experimental scanning display region 570 for displaying whether scanning is possible, and when the scanning system 20 is idle and in a normal state, an “experimental scan” button of the experimental scanning display region 570 may be clicked only, and the object is scanned to obtain the target experimental data. In some embodiments, the experimental scanning display region 570 is also configured to display a verification result of the target experimental data, and when the target experimental data is correct, the “experimental scan” button of the experimental scanning display region 570 may be clicked only and the target experimental data is obtained. When the target experimental data is incorrect or when the scanning system 20 is busy, the experimental data may be preregistered by a registration operation, so that the scanning system 20 and the experimental information management system 10 may operate in parallel. When the scanning system 20 is busy, the registration operation of experimental data may be carried out at the same time, and when the scanning system 20 is idle and/or in the normal state, it directly responds to a scanning operation to retrieve the target experimental data from the experimental information management system 10 and carry out the scanning in accordance with the target experimental data, thus improving work efficiency.

The person skilled in the art may understand that all or part of the process of realizing the method of the above embodiments may be accomplished by instructing the relevant hardware through a computer program, the program of which may be stored in a computer-readable storage medium. The computer-readable storage medium is a disk, a CD-ROM, a read-only storage memory, or a randomized storage memory, etc.

The embodiments of the present disclosure provide an experimental information management system, method, and an imaging system, comprising: selecting at least to-be-processed experimental data from at least one piece of historical experimental data through an experimental information management module, and then modifying the to-be-processed experimental data through an experimental information registration module, which may generate target experimental data, i.e., the target experimental data may be generated by modifying the to-be-processed experimental data without requiring experimenter to register individual animals before each experiment, which effectively avoids the technical problem of registration error and shortens the time of registration, and thus improves the animal experiment efficiency.

Furthermore, the embodiment of the present disclosure provides a variety of ways to modify experimental data by setting the experimental information registration module to include a data block replacement unit and a data modification unit, which respectively realize replacing an entire animal experimental data block and modify a single data item, which can further improve the applicability of the experimental information management system.

The above detailed description of the experimental information management system, method, and imaging system provided by the present disclosure is provided, and specific examples are applied herein to illustrate the principles and the implementation of the present disclosure, and the above illustration of the examples is only used to help understand the method of the present disclosure and its core ideas; at the same time, for the technical personnel in the field, based on the ideas of the present disclosure, there will be changes in the specific implementation and scope of application, in summary, the contents of the present disclosure should not be interpreted as a limitation of the present disclosure.

1. An experimental information management system, comprising an experimental data center module, an experimental information management module, and an experimental information registration module, wherein:
the experimental data center module is configured to store at least one piece of historical experimental data that has been registered;
the experimental information management module is configured to select, in response to a selection operation, at least one candidate piece of historical experimental data from the experimental data center module and determine to-be-processed experimental data from the at least one candidate piece of historical experimental data;
the experimental information registration module is configured to generate, in response to a modification operation, target experimental data by modifying the to-be-processed experimental data; and
the experimental data center module is further configured to store, in response to a registration operation, the target experimental data.

2. The experimental information management system of claim 1, wherein:
the experimental information management module includes a selection unit and a determination unit;
the selection unit is configured to select the at least one candidate piece of historical experimental data from the experimental data center module based on a selection keyword; and
the determination unit is configured to determine the to-be-processed experimental data from the at least one candidate piece of historical experimental data in response to a determination operation.

3. The experimental information management system of claim 2, wherein:
the historical experimental data includes a historical experimental animal data block and a historical experimental scanning data block;
the modification operation includes an overall replacement sub-operation;
the experimental information registration module includes a data block replacement unit; and
the data block replacement unit is configured to perform, in response to the overall replacement sub-operation, an overall replacement on a historical experimental animal data block or the historical experimental scanning data block in the to-be-processed experimental data.

4. The experimental information management system of claim 3, wherein:
the data block replacement unit includes a data block retrieve sub-unit and a data block replacement sub-unit;
the data block retrieve sub-unit is configured to retrieve at least one piece of to-be-selected historical experimental data from the experimental data center module based on a replacement keyword, the replacement keyword being different from the selection keyword; and
the data block replacement sub-unit is configured to determine, in response to a determination operation, target to-be-selected historical experimental data from the at least one piece of to-be-selected historical experimental data, and replace a historical experimental animal data block in the to-be-processed experimental data with the target to-be-selected historical experimental data or replace the historical experimental scanning data block in the to-be-processed experimental data with the target to-be-selected historical experimental data.

5. The experimental information management system of claim 1, wherein:
the historical experimental data comprises a plurality of historical experimental data items;
the modification operation further comprises a single-item modification sub-operation;
the experimental information registration module further includes a data modification unit; and
the data modification unit is configured to modify, in response to the single-item modification sub-operation, at least one historical experimental data item in a plurality of historical experimental data items in the to-be-processed experimental data.

6. The experimental information management system of claim 5, wherein:
the experimental information registration module further includes a memory unit;
the memory unit is configured to record names of registered experimenters and/or names of registered experimental projects; and
the data modification unit is further configured to select, in response to the single-item modification sub-operation, a target experimenter and/or a target experimental project from the names of the registered experimenters and/or the names of the registered experimental projects.

7. The experimental information management system of claim 1, wherein the experimental information registration module is further configured to generate a new experimental number to replace a historical experimental number in the to-be-processed experimental data to generate the target experimental data with the new experimental number.

8. The experimental information management system of claim 4, wherein:
the data replacement sub-unit includes a determination sub-unit, an animal data updating sub-unit, and an animal data replacement sub-unit;
the determination sub-unit is configured to, in response to the determination operation, determine target to-be-selected historical experimental data from the at least one piece of to-be-selected historical experimental data;
the animal data updating sub-unit is configured to update a historical animal data block in the target to-be-selected historical experimental data; and
the animal data replacement sub-unit is configured to replace a historical experimental animal data block in the to-be-processed experimental data with an updated historical experimental animal data block in the target to-be-selected historical experimental data.

9. The experimental information management system of claim 8, wherein the animal data updating sub-unit includes an updated model establishment sub-unit and an animal data information updating sub-unit,
the updated model establishment sub-unit is configured to establish an animal information updating model for an individual animal; and
the animal data information updating sub-unit is configured to update a historical experimental animal data block in the target to-be-selected historical experimental data based on the animal information updating model.

10. The experimental information management system of claim 3, wherein the historical experimental animal data block includes at least one of an animal number, an animal name, a species type, an animal age or an animal weight.

11. The experimental information management system of claim 3, wherein:
the historical experimental scanning data block includes a historical experimental basic data block, a historical scanning protocol, and a historical placement position, and
the historical experimental basic data block includes at least one of an experimental number, an experimental name, an experimenter or an experimental project.

12. An experimental information management method, comprising:
storing at least one piece of historical experimental data that has been registered using an experimental data center module;
selecting at least one candidate piece of historical experimental data from the experimental data center module, in response to a selection operation, using an experimental information management module, and determining to-be-processed experimental data from the at least one candidate piece of historical experimental data;
generating target experimental data by modifying the to-be-processed experimental data, in response to a modification operation using an experimental information registration module; and
storing the target experimental data in response to a registration operation using the experimental data center module.

13-15. (canceled)

16. The method of claim 12, wherein:
the experimental information management module includes a selection unit and a determination unit;
the selection unit is configured to select the at least one candidate piece of historical experimental data from the experimental data center module based on a selection keyword; and
the determination unit is configured to determine the to-be-processed experimental data from the at least one candidate piece of historical experimental data in response to a determination operation.

17. The method of claim 16, wherein:
the historical experimental data includes a historical experimental animal data block and a historical experimental scanning data block;
the modification operation includes an overall replacement sub-operation;
the experimental information registration module includes a data block replacement unit; and
the data block replacement unit is configured to perform, in response to the overall replacement sub-operation, an overall replacement on a historical experimental animal data block or the historical experimental scanning data block in the to-be-processed experimental data.

18. The method of claim 17, wherein:
the data block replacement unit includes a data block retrieve sub-unit and a data block replacement sub-unit;
the data block retrieve sub-unit is configured to retrieve at least one piece of to-be-selected historical experimental data from the experimental data center module based on a replacement keyword, the replacement keyword being different from the selection keyword; and
the data block replacement sub-unit is configured to determine, in response to a determination operation, target to-be-selected historical experimental data from the at least one piece of to-be-selected historical experimental data, and replace a historical experimental animal data block in the to-be-processed experimental data with the target to-be-selected historical experimental data or replace the historical experimental scanning data block in the to-be-processed experimental data with the target to-be-selected historical experimental data.

19. The method of claim 12, wherein:
the historical experimental data comprises a plurality of historical experimental data items;
the modification operation further comprises a single-item modification sub-operation;
the experimental information registration module further includes a data modification unit; and
the data modification unit is configured to modify, in response to the single-item modification sub-operation, at least one historical experimental data item in a plurality of historical experimental data items in the to-be-processed experimental data.

20. The method of claim 19, wherein:
the experimental information registration module further includes a memory unit;
the memory unit is configured to record names of registered experimenters and/or names of registered experimental projects; and
the data modification unit is further configured to select, in response to the single-item modification sub-operation, a target experimenter and/or a target experimental project from the names of the registered experimenters and/or the names of the registered experimental projects.

21. An imaging system, comprising an experimental information management system and a scanning system, wherein the scanning system is configured to retrieve target experimental data from the experimental information management system in response to a scanning operation and perform scanning based on the target experimental data, and the experimental information management system includes an experimental data center module, an experimental information management module, and an experimental information registration module, and wherein:
the experimental data center module is configured to store at least one piece of historical experimental data that has been registered;
the experimental information management module is configured to select, in response to a selection operation, at least one candidate piece of historical experimental data from the experimental data center module and determine to-be-processed experimental data from the at least one candidate piece of historical experimental data;
the experimental information registration module is configured to generate, in response to a modification operation, the target experimental data by modifying the to-be-processed experimental data; and
the experimental data center module is further configured to store, in response to a registration operation, the target experimental data.

22. The imaging system of claim 21, wherein:
the scanning system comprises a receiving unit, a retrieving unit and a scanning unit;
the receiving unit is configured to receive an experimental number of the target experimental data;
the retrieving unit is configured to retrieve the target experimental data from an experimental data center module, based on the experimental number of the target experimental data; and
the scanning unit is configured to scan an object based on the target experimental data.

23. The imaging system of claim 22, wherein the scanning system includes a verifying module, the verifying module being configured to:
verify whether the target experimental data is correct, and
when the target experimental data is correct, perform scanning according to the target experimental data.
